(19) United States
(12) Patent Application Publication
(10) Pub. No.: US 2023/0216067 A1
(43) Pub. Date: Jul. 6, 2023

(54) BIPOLAR PLATE REACTANT CHANNELS WITH LOCAL VARIATIONS TO INCREASE DIFFUSION THROUGH A GAS DIFFUSION LAYER

(71) Applicant: HYDROGENICS CORPORATION, Mississauga (CA)

(72) Inventors: Salvatore RANIERI, Etobicoke (CA); Rainey Yu WANG, Richmond Hill (CA); Nathaniel Ian JOOS, Toronto (CA)

(21) Appl. No.: 18/069,717

(22) Filed: Dec. 21, 2022

Related U.S. Application Data
(60) Provisional application No. 63/297,067, filed on Jan. 6, 2022.

(51) Int. Cl. H01M 8/026; H01M 8/0267

(52) U.S. Cl. CPC H01M 8/026; H01M 8/0267

(57) ABSTRACT

The present disclosure generally relates to systems and methods for inducing a secondary flow from a first groove in a bipolar plate of a fuel cell to a second groove in the bipolar plate over a first land in the bipolar plate wherein the land is adjacent to a compressed section of a gas diffusion layer in the fuel cell, and wherein the secondary flow increases locally available oxygen and hydrogen at the membrane electrode assembly adjacent to the compressed section of the gas diffusion layer.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Ser. No. 63/297,067 filed on Jan. 6, 2022, the entire disclosure of which is hereby expressly incorporated herein by reference.

### TECHNICAL FIELD

The present disclosure generally relates to systems and methods for modifying a bipolar plate (BPP) flow field so that the diffusion in a gas diffusion layer (GDL) under a land region of the bipolar plate (BPP) is enhanced.

### BACKGROUND

Several fuel cells are assembled into a fuel cell stack and operated to provide power or energy for industrial, commercial, or personal use. The fuel cell is a multi-component assembly comprising a membrane electrode assembly (MEA) at the center, a gas diffusion layer (GDL) on both sides of the membrane electrode assembly (MEA), and a bipolar plate (BPP) on the other side of each of the gas diffusion layer (GDL). The membrane electrode assembly (MEA) is a component that enables electrochemical reactions in the fuel cell. Typically, the fuel cell stack is assembled with repeated units of the aforementioned components (e.g., MEA, GDL, and BPP) in a configuration amenable to useful and reliable operation.

The gas diffusion layer (GDL) is highly hydrophobic and repels the liquid water produced during the electrochemical reactions away from the reaction site. Since water is a byproduct of the fuel cell operation, there may be instances when condensation is thermodynamically favored to form water at the surface of the fuel cell or fuel cell stack. Removal of water from the reaction site is critical because liquid water can effectively block the oxygen and hydrogen from reaching the reaction site. Additionally, if excessive liquid water is left in contact with the membrane electrode assembly (MEA), it can cause accelerated aging of the fuel cell or fuel cell stack by reacting with the sensitive and reactive catalyst layer of the membrane electrode assembly (MEA).

Most common bipolar plate (BPP) designs known in the art use either an embossed plate or a corrugated formed sheet that comprise lands and grooves designed with very specific geometry and design considerations to facilitate the flow of reactants and maintain contact with the gas diffusion layer (GDL) and membrane electrode assembly (MEA). The gas diffusion layer (GDL) sections under the grooves of the bipolar plate (BPP) are uncompressed and are essentially floating between the flow channels. Though these uncompressed sections of the gas diffusion layer (GDL) offer no electrical pathway, they are necessary to enable fluidic passageways for the reactants. Additionally, these uncompressed sections facilitate an increased breathability within the gas diffusion layer (GDL).

One way to increase the efficiency of the gas diffusion layer (GDL) is to increase the diffusion of the gas diffusion layer (GDL) under the lands of the bipolar plate (BPP). Accordingly, described herein are systems and methods comprising modifications to a bipolar plate (BPP) flow field so that the diffusion of the gas diffusion layer (GDL) under the lands of the bipolar plate (BPP) is enhanced.

### SUMMARY

Embodiments of the present invention are included to meet these and other needs.

In one aspect, described herein, a fuel cell system comprises a membrane electrode assembly, a bipolar plate, and a local feature. The membrane electrode assembly is on a first side of a gas diffusion layer. The bipolar plate is on a second side of a gas diffusion layer, and the bipolar plate comprises at least one channel. Each channel comprises at least one groove and at least one land. The local feature induces a secondary flow from a first groove in a first channel to a second groove in a second channel over a first land separating the first channel and the second channel. The at least one land is adjacent to a compressed section of the gas diffusion layer. The secondary flow increases locally available oxygen and hydrogen at the membrane electrode assembly adjacent to the compressed section of the gas diffusion layer.

In some embodiments, the system may comprise a first local feature in the first channel and a second local feature in the second channel. In some embodiments, the first local feature may be a first pinch and the second local feature may be a second pinch. In some embodiments, the first local feature may have the same configuration as the second local feature.

In some embodiments, the local feature may include at least one local decompression rib. In some embodiments, the local feature may include at least one pinch. In some embodiments, the local features may include a dimple or a notch.

In some embodiments, a frequency of the local feature may depend on a length of the channel, and the local feature may be positioned along the length of the channel. In some embodiments, the frequency of the local feature along the channel may increase as the channel length progresses.

In some embodiments, the local feature may be positioned along the length of the channel.

According to a second aspect, described herein, a method of operating a fuel cell stack operating a plurality of fuel cells comprising a membrane electrode assembly on a first side of a gas diffusion layer and a bipolar plate on a second side of the gas diffusion layer comprising at least a first channel and a second channel, wherein the first channel and the second channel comprise one or more grooves and one or more lands, increasing a pressure differential between the first channel and the second channel by including a local feature, inducing a secondary flow from a first groove in the first channel to a second groove in the second channel, increasing efficiency of the gas diffusion layer, and decreasing water accumulation in the first groove and the second groove.

In some embodiments, inducing the secondary flow may include at least one pinch. In some embodiments, inducing the secondary flow may include a dimple or a notch. In some embodiments, the method may further comprise controlling the magnitude of the secondary flow by altering the characteristics of the at least one pinch, and altering the characteristics may include changing at least one of a length of a pinched section, a width of the pinch, or a height of the pinch.

In some embodiments, inducing a secondary flow may include at least one local decompression rib. In some embodiments, increasing efficiency of the gas diffusion layer may include decompressing the gas diffusion layer locally to direct the secondary flow through a decompression ridge. In some embodiments, inducing a secondary flow may include introducing a local pressure drip.

In some embodiments, a frequency of the local feature may depend on a length of the channel, and the local feature may be positioned along the length of the channel. In some embodiments, the frequency of the local feature along the channel may increase as the channel length progresses.

In some embodiments, the local feature may be positioned along the length of the channel.

### BRIEF DESCRIPTION OF THE DRAWINGS

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, a hydrogen delivery system, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 is an illustration of anode, cathode, and coolant channels of flow fields in a fuel cell stack;

FIG. 3A is an illustration identifying a side section profile region of a channel that can be modified to increase the diffusion of the gas diffusion layers (GDL) under the land of a flow field by locally pinching the channel to produce regions of local pressure drop and by including a decompression rib;

FIG. 3B is an illustration of a side section profile of a modified channel with a groove including a raised portion;

FIG. 3C is an illustration of a side section profile of an unmodified channel;

FIG. 4A is an illustration identifying a top section profile region of the channel that can be modified to increase the diffusion of the gas diffusion layers (GDL) under the land of a flow field by including decompression ribs and a local pinch that can cause a reduction in the width of a groove in the channel;

FIG. 4B is an illustration of a top section profile of the modified channel with the decompression ribs and a reduction in the width of a groove;

FIG. 4C is an illustration of a top section profile of the unmodified channel;

FIG. 5 is an illustration of adjacent channels that have multiple staggered channel pinches and decompression ribs;

FIG. 6A is an illustration of a channel with a notch to aid in assembly and or to further aid in maintaining the required flow and/or pressure drop across the length of the channel; and

FIG. 6B is an illustration of a channel with a dimple to aid in assembly and or to further aid in maintaining the required flow and/or pressure drop across the length of the channel.

These and other features, aspects, and advantages of the present invention will become better understood when the following detailed description is read with reference to the accompanying drawings described herein. Reference is also made to the accompanying drawings that form a part hereof and in which is shown by way of illustration specific embodiments in which the invention may be practiced. These embodiments are described in sufficient detail to enable those skilled in the art to practice what is claimed and it is to be understood that other embodiments may be utilized and that logical, mechanical, and electrical changes may be made without departing from the spirit and scope of the claims. The following detailed description is, therefore, not to be taken in a limiting sense.

### DETAILED DESCRIPTION

The present disclosure is directed to systems and methods used to increase the efficiency of the gas diffusion layer (GDL) 24, 26. The present systems and methods increase the efficiency of the gas diffusion layer (GDL) 24, 26 by varying the pressure along the length of channels 120, 122 in the bipolar plate (BPP) 28, 30 and/or locally decompressing the gas diffusion layer (GDL) 24, 26. Such increased pressure on the BPP 28, 30 or decreased pressure on the GDL 24, 26 promotes flow between the channels 120, 122 in the bipolar plate (BPP) 28, 30.

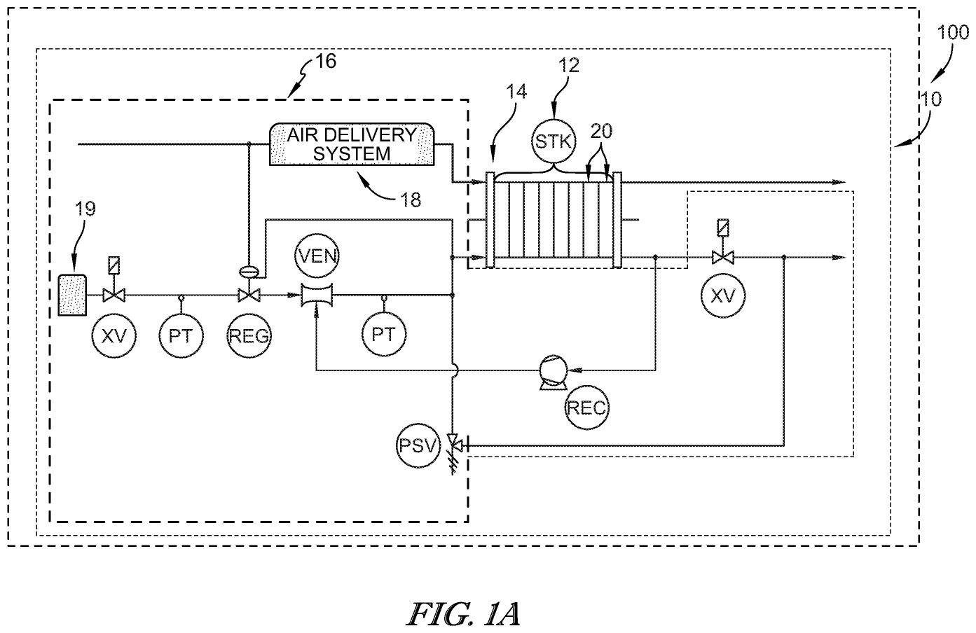

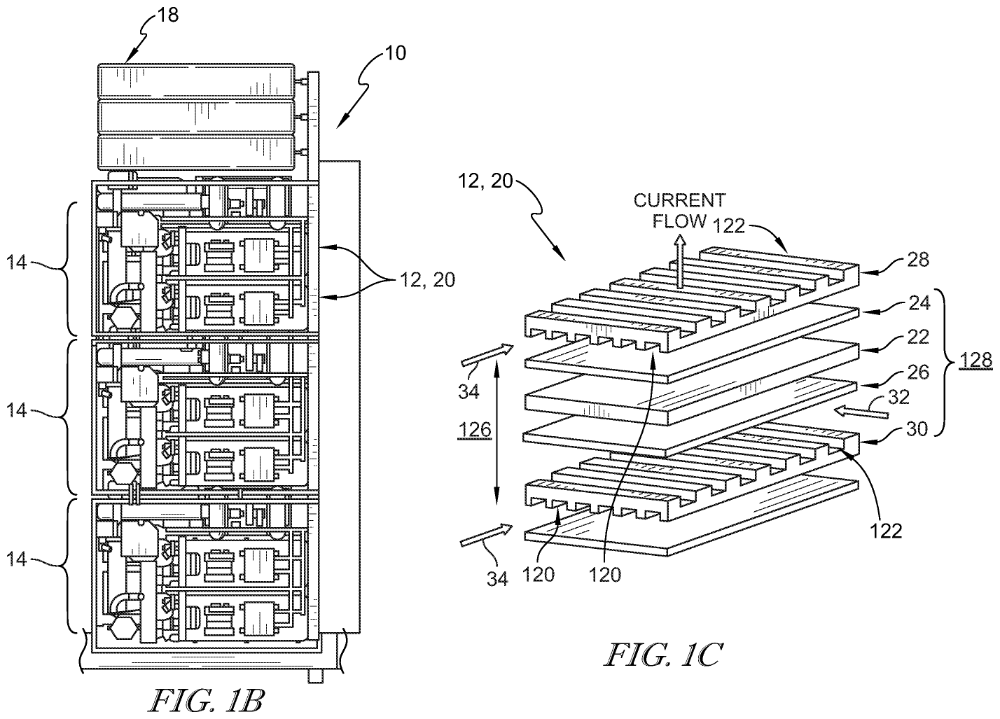

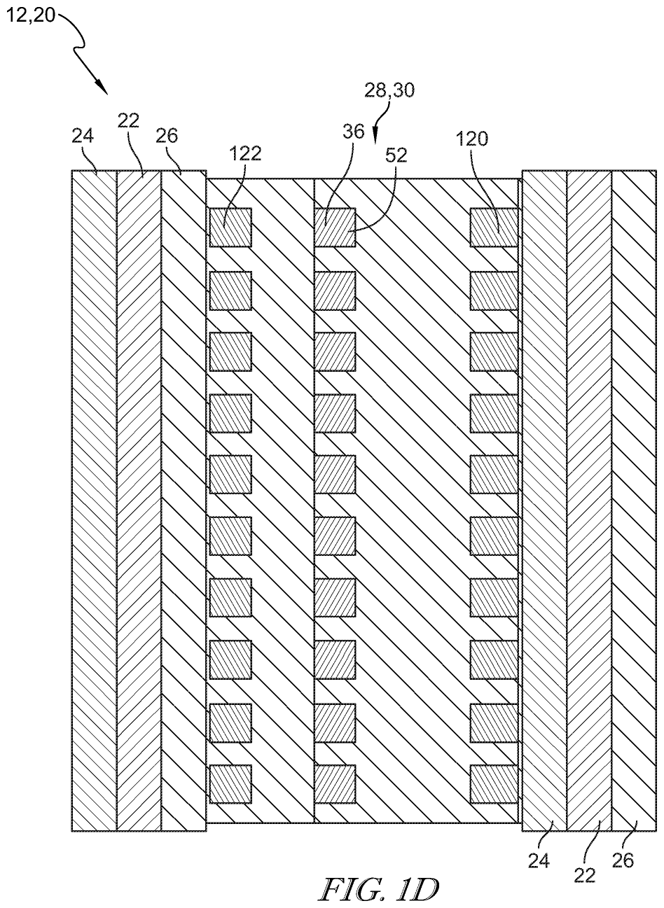

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layer (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 128.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 126 of each fuel cell 20 through oxidant flow fields 120 and/or fuel flow fields 122 formed on outer surfaces of the bipolar plates (BPP) 28, 30. The active area 126, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 120, 122 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 122 for transfer of fuel 32 on one side of the plate 28, 30 for interaction with the gas diffusion layer (GDL) 26, and oxidant flow fields 120 for transfer of oxidant 34 on the second, opposite side of the plate 28, 30 for interaction with the gas diffusion layer (GDL) 24.

As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants 32, 34. The bipolar plates (BPP) 28, 30 are compressed against adjacent gas diffusion layers (GDL) 24, 26 to isolate and/or seal one or more reactants 32, 34 within their respective pathways 122, 120 to maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system, or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

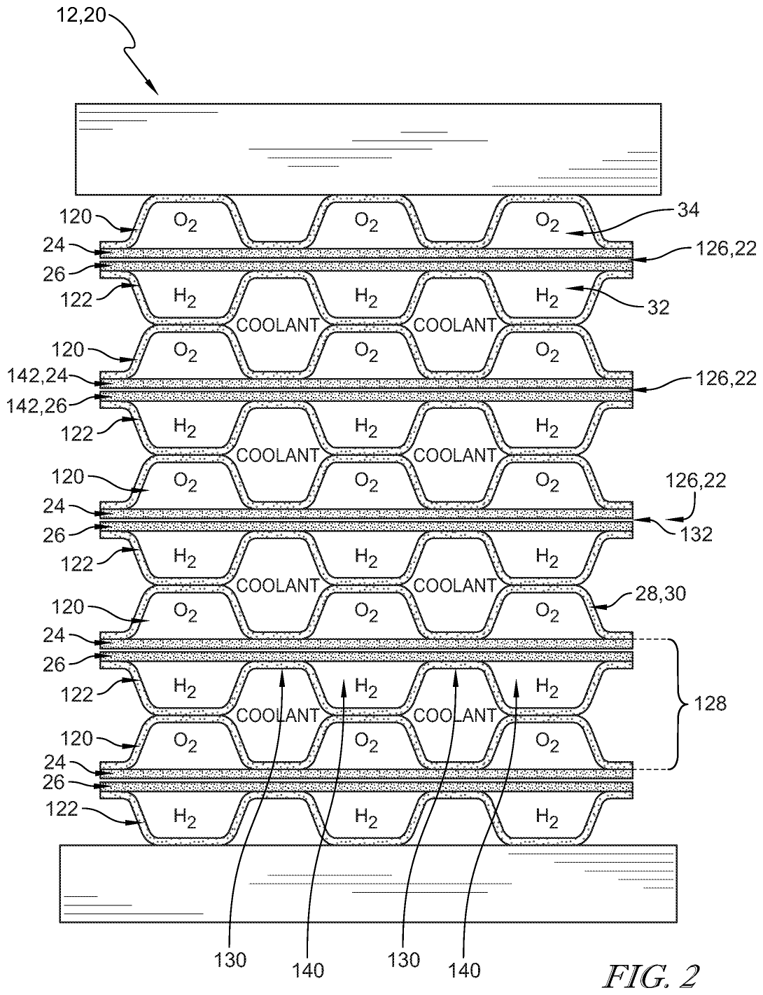

FIG. 2 shows a repeating unit 128 of a fuel cell 20. This fuel cell 20 embodiment comprises a single membrane electrode assembly (MEA) 22. The fuel cell 20 embodiment also comprises one or more gas diffusion layers (GDL) 24, 26 on either or both sides of the membrane electrode assembly (MEA) 22. Finally, the fuel cell 20 also comprises a bipolar plate (BPP) 28, 30 on the exterior and/or external side of each gas diffusion layer (GDL) 24, 26.

The gas diffusion layer (GDL) 24, 26 has three primary roles within the fuel cell 20. The gas diffusion layer (GDL) 24, 26 physically enables very uniform and laminar diffusion from the channel 120, 122 path to the membrane electrode assembly (MEA) 22. The gas diffusion layer (GDL) 24, 26 creates this uniform flow and/or diffusion by leveraging a very porous and finely meshed network of fibers 142 (e.g., graphite fibers). This network of fibers 142 functions as a flow straightener in order to reduce the turbulence of the anode and cathode flow and provides a steady stream of reactants 32, 34 to the reaction site.

Similar to the other components in the fuel cell 20, the gas diffusion layer (GDL) 24, 26 must possess a high electrical conductivity. The current flows through the entire fuel cell stack 12, and electrical conductivity and/or electrical resistivity determine ohmic losses in the fuel cell stack 12. The ohmic losses may be in the form of excess heat generation.

As shown in FIG. 2, the single repeating unit 128 of the fuel cell 20 produces a voltage output. In some exemplary embodiments, more than one repeating units 128 may be stacked together in order to multiply the voltage output of the single fuel cell 20 by the number of fuel cells 20 stacked together. For example, the fuel cell stack 12 may have from about 10 to about 500 fuel cells, including any specific or range of number of fuel cells 20 comprised therein. For example, the fuel cell stack 12 may have from about 40 to about 100 fuel cells, from about 100 to about 200 fuels cells, from about 200 to about 300 fuels cells, or from about 300 to about 400 fuels cells, including every number of fuel cells 20 comprised therein. The fuel cell stack 12 may include any type of fuel cells 20, as discussed previously.

The cross-sectional area of the fuel cell 20 and/or fuel cell stack 12 may determine a current operating range of the fuel cell 20 and/or fuel cell stack 12. In some embodiments, the product of the number of fuel cells 20 comprised in a fuel cell stack 12 and the area of each fuel cell 20 may indicate an overall power rating of the fuel cell stack 12. The characteristics of the membrane electrode assembly (MEA) 22 and the gas diffusion layer (GDL) 24, 26 may also impact the power rating of the fuel cell stack 12.

As shown in FIGS. 1C, 1D, and 2, the bipolar plate (BPP) 28, 30 may be responsible for the transport of reactants 32, 34 and cooling fluid 36 in a fuel cell 20. The bipolar plate (BPP) 28, 30 of the fuel cell 20 may be configured to facilitate a flow pathway and maintain contact with the GDL-MEA-GDL assembly. The gas diffusion layer (GDL) 24, 26 sections under the lands 130 are under high compression forces because of the stack compression which is necessary to maintain surface contact and electrical conductivity between all the repeating stack components. The pore sizes of the gas diffusion layer (GDL) 24, 26 are reduced under compression, making the gas diffusion layer (GDL) 24, 26 less breathable and less able to diffuse the reactants. The fuel cell 20 comprises both compressed and uncompressed sections of the gas diffusion layer (GDL) 24, 26 in certain proportions as they have competing effects of increasing diffusion versus increasing electrical conductivity.

As shown in FIG. 2, in one fuel cell 20 and/or fuel cell stack 12 embodiment, the bipolar plate (BPP) 28, 30 may be responsible for uniformly distributing reactants 32, 34 to the active area 126 of each fuel cell 20 through oxidant channels or flow fields 120 and/or the fuel (e.g., hydrogen) channels or flow fields 122. The active area 126, where the electrochemical reactions occur to generate power produced by the fuel cell 20, may be centered within the gas diffusion layer (GDL) 24, 26 and the bipolar plate (BPP) 28, 30. In other embodiments, the bipolar plate (BPP) 28, 30 may be responsible for isolating or sealing the reactants 32, 34 within their respective pathways, all while being electrically conductive and robust.

The flow fields 120, 122 consist of one or more millimeter scale networks that direct the bulk supply of reactants 32, 34 and diffuse the reactants 32, 34 over the active portion of the fuel cells 20. The active area 126 of the fuel cell 20 is the region of the fuel cell 20 where both the anode and cathode flow fields 120, 122 directly overlap. The open-faced channel of the anode and cathode flow fields 120, 122 are exposed directly overtop the gas diffusion layer (GDL) 24, 26 and the membrane electrode assembly (MEA) 22. Fuel molecules present in the active area 126 of the membrane electrode assembly (MEA) 22 may produce a voltage potential and a current draw or a load may be supported by the reactant flow rate. As the current demand on the fuel cell 20 increases, the molar flow of the reactants 32, 34 is required to increase proportionally, in accordance to Faraday's law of electrolysis.

FIG. 2 shows the active area 126 may also have a lead-in or a header region 132 before and/or after the membrane electrode assembly (MEA) 22. For example, the header region 132 may ensure better distribution over the membrane electrode assembly (MEA) 22, while offering a compact way to arrange the design of the bipolar plate (BPP) 28, 30.

Referring back to FIG. 1C, the fuel cell 20 and/or the fuel cell stack 12 is supplied with an oxidant (e.g., atmospheric air, oxygen, humidified air) 34 at the cathode side. The fuel cell 20 and/or the fuel cell stack 12 is supplied with fuel (e.g., hydrogen) 32 at the anode side (e.g., at the anode). The fuel cell 20 and/or the fuel cell stack 12 that is supplied with fuel 32 and oxidant 34 provides the necessary reaction to generate power. Water is a standard byproduct of the electrochemical reactions performed to generate power.

Referring to FIG. 2, in some embodiments, a change in geometry of the cathode channels or flow fields 120 and/or the anode channels or flow fields 122 may allow or enable localized fluid acceleration to better mitigate probable water accumulation. In one embodiment, velocity of the flow of reactants 32, 34 (e.g., oxygen, air, fuel) may vary with the cross-sectional area of the anode and/or cathode channels or flow fields 120, 122. For example, in some embodiments, the velocity of the flow of reactants 32, 34 may be locally increased by reducing the size of the channels or flow field 120, 122 in the direction of reactant flow. The channels or flow fields 120, 122 include one or more, more than one, multiple, and/or a plurality of lands or channel lands 130, as well as grooves or channel grooves 140 along their length.

In the flow field of anode channels 120 or cathode channels 122, if the channels 120, 122 start and end at the same junction, the channels 120, 122 are deemed to be in a parallel flow configuration. If the channels 120, 122 are designed with no spatial or geometrical differences, the pressure and the pressure drop along any one channels (in the anode network or in the cathode network) 120, 122 is identical to other channels 120, 122 in the same network. It may be advantageous to induce or force flow over the land 130 and subsequently through the gas diffusion layer (GDL) 24, 26, in either the anode channels 120, the cathode channels 122, or both.

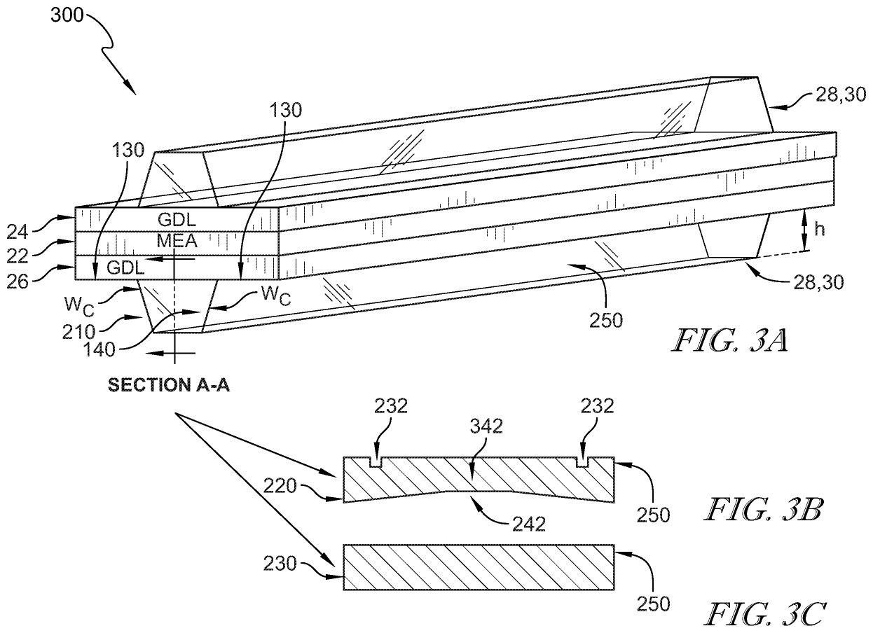

As shown in FIGS. 3A-3C, a method of inducing flow through a channel 210 in a fuel cell 300 may include introducing a local pressure drop via one or more, more than one, multiple, or a plurality of pinches 342, where the channel 210 will exhibit changes in pressure. The channel 210 may be an anode channel 120 or a cathode channel 122. Any channel 210 within the bipolar plate (BPP) 28, 30 may also have one or more pinches 342. For example, the channel 210 may include about 1 to about 50 pinches 342, including any specific or range of number of pinches 342 comprised therein. For example, the channel 210 may include about 1 to about 4, about 4 to about 10, about 10 to about 20, about 20 to about 50, more than 40 pinches 342 or more than 50 pinches 342, including any number or range of pinches 342 comprised therein.

The pinch 342 may result in a change in the configuration of the groove 140 of the channel 210. The pinch 342 could occupy from about 1% of the groove 140 to about 100% of the groove 140, including any specific or range of percentage comprised therein. For example, the pinch 342 could occupy from about 1% of the groove 140 to about 20% of the groove 140, about 20% of the groove 140 to about 40% of the groove 140, about 40% of the groove 140 to about 60% of the groove 140, about 60% of the groove 140 to about 80% of the groove 140, or about 80% of the groove 140 to about 100% of the groove 140, including any percentage or range of percentage comprised therein.

Specifically, the pinch 342 may cause a change in area, volume, and/or cross-sectional area of the groove 140 at, around, near, upstream, and/or downstream of the location of the pinch 342 within the channel 210. An exemplary pinch 342 in the BPP 28, 30 may occur by locally, manually, and/or mechanically pinching or squeezing the channel 210 in the bipolar plate (BPP) 28, 30 to reduce or minimize the area, volume, and/or cross-sectional area at site of the pinch 342. Because the channel 210 is still in a parallel configuration, the total pressure drop between the ends of the channel 210 will remain the same in the channel 210 and any channel adjacent to it. Importantly, the presence of one or more such pinches 342 in the BPP 28, 30 can introduce a local pressure difference along the channel 210.

In addition to pinches 342, the bipolar plate (BPP) 28, 30 of the fuel cell 300 may also be modified to increase the diffusion of the gas diffusion layers (GDL) 24, 26 under the land 130 of the bipolar plate (BPP) 28, 30 (see FIGS. 3A-3C). This is not the case with unmodified channels of the BPP 28, 30 that are known in the art.

As shown in FIG. 3C, a side section profile along section A-A of an unmodified channel 230 of the BPP 28, 30 known in the art does not include any such pinch 342, land 130, and/or groove 140. Alternatively, the present fuel cell 300 includes the modified channel 210/220 that has a groove 140 with a width we and a height h. As seen in FIG. 3B, a side section profile along section A-A of a modified channel 220 of the present disclosure illustrates the groove 140 including a raised portion 242. The raised position 242 may be a consequence because of the presence and/or incorporation of the local pinch 342.

This raised portion 242 may or may not be required to be incorporated with every pinch 342. Without the raised portion 242, the aspect ratio (w_{C}:h) of the channel 210/220 will change. Such change in aspect ratio may negatively affect the metal strain required to form the pinch 342 if the channel 210 is made from sheet metal. The raised portion 242 may not be required if the bipolar plate (BPP) 28, 30 is made of graphite as the mechanical properties of graphite is not similarly affected.

As shown in FIG. 3B, the side section profile along section A-A of a modified channel 220 also illustrates one or more decompression ribs 232. The decompression ribs 232 may be located near the side wall 250 of the channel 210 and/or on the land 130 to locally decompress the gas diffusion layers (GDL) 24, 26. Local decompression of the gas diffusion layers (GDL) 24, 26 may increase the diffusion of gases through the gas diffusion layers (GDL) 24, 26.

Presence of the decompression rib 232 on the land 130 along with one or more local pinches 342 may be used to accurately control the location of flow between adjacent channels 210 in a bipolar plate (BPP) 28, 30. Inclusion of the decompression rib 232 and/or the local pinch 342 may also promote flow between adjacent channels 210 in the bipolar plate (BPP) 28, 30. In some embodiments, the bipolar plate (BPP) 28, 30 may include multiple pinches 342 and/or multiple decompression ribs 232. For example, the bipolar plate (BPP) 28, 30 may include 1 to 50 pinches 342 and/or multiple decompression ribs 232, including any specific number or range comprised therein. For example, the bipolar plate (BPP) 28, 30 may include 1 to 4, 4 to 10, 10 to 20, 20 to 50, or more than 40 pinches 342, including any number or range of pinches 342 comprised therein. Additionally, or alternatively, the bipolar plate (BPP) 28, 30 may include 1 to 4, 4 to 10, 10 to 20, 20 to 50, or more than 40 decompression ribs 232, including any number or range of decompression ribs 232 comprised therein.

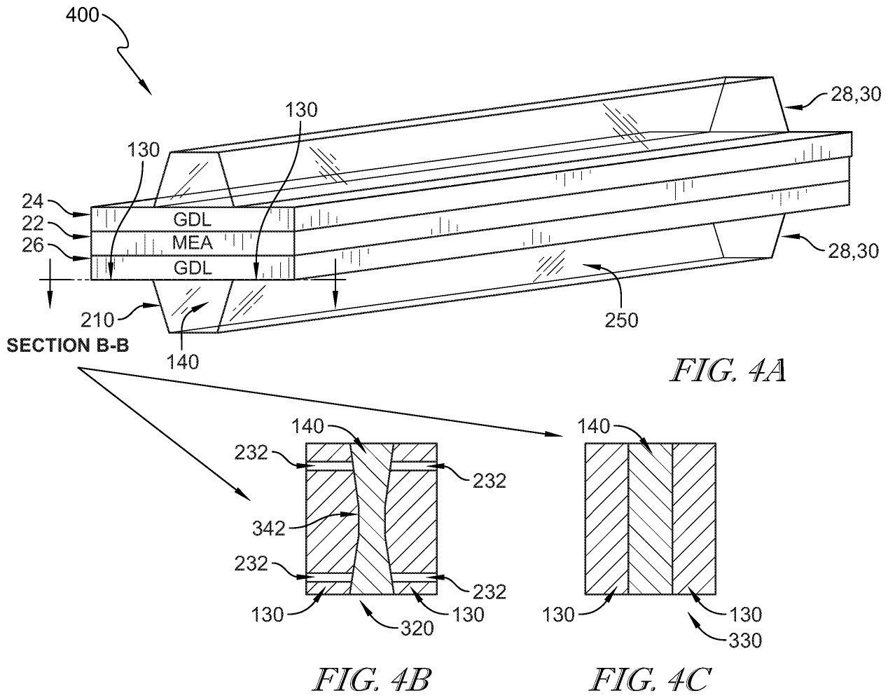

FIGS. 4A-4C shows a section of the top profile of an embodiment of a fuel cell 400. The fuel cell 400 includes both the decompression rib 232 and a reduction in the width of the groove 140 because of the presence of the local pinch 342 in the channel 210. Unlike a top section profile along section B-B of an unmodified channel 330 of the bipolar plate (BPP) 28, 30 known in the art and shown in FIG. 4C, which does not include any decompression ribs 232 or reduction in the width of the groove 140, a top section profile along section B-B of a modified channel 320 of the present disclosure shown in FIG. 4B includes one or more of these features (i.e., presence of a pinch 342, decompression ribs 232, and/or reduction in the width of the groove 140).

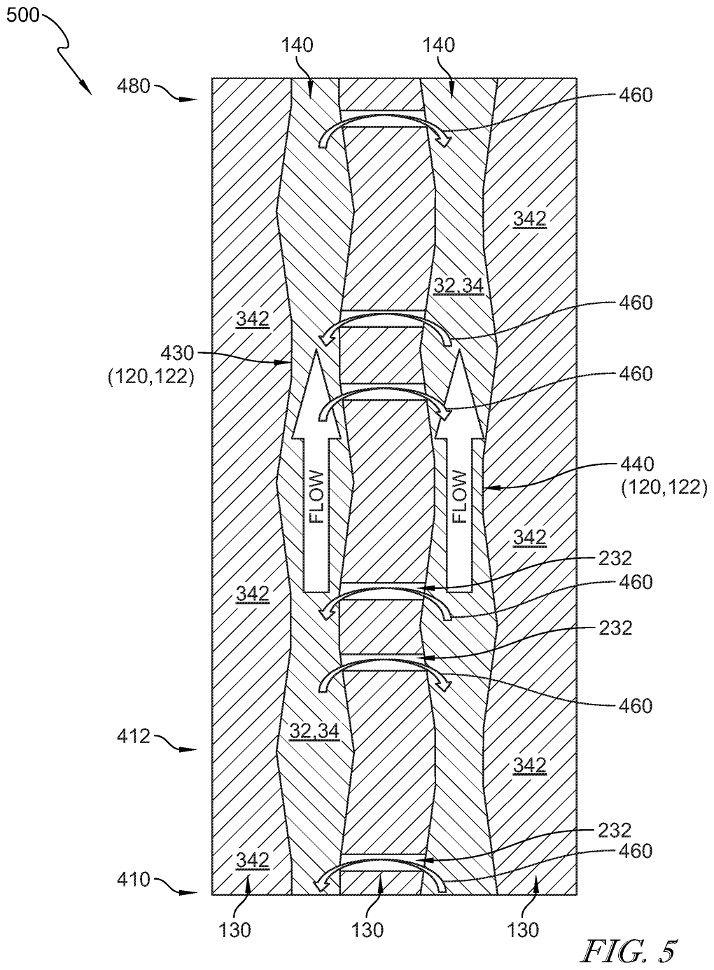

FIG. 5 illustrates adjacent channels 430, 440 that have multiple staggered (e.g., non-overlapping or non-adjacent) channel pinches 342 and decompression ribs 232. Channels 430, 440 may be anode channels 120 or cathode channels 122. The full-length channels 430, 440 may be configured to include several pinched (342) and ribbed (232) sections to promote secondary flow. Secondary flow between neighboring channels 430, 440 is driven by local pressure differential and helps to increase the locally available oxygen and hydrogen at the membrane electrode assembly (MEA) 22 catalyst layer under the lands 130. Secondary flow between neighboring channels may reduce the fuel cell 20, 300, 400 aging process, increase the fuel cell 20, 300, 400 performance, and/or overall performance of the fuel cell stack 12.

Adjacent channels 430, 440 may have the same pinch 342, land 130, and/or groove 140 geometry, but these features may be offset (e.g., by a specific distance) along the length of the respective channels 430, 440. Alternatively, adjacent channels 430, 440 may have different pinch 342, land 130, and/or groove 140 geometry. The characteristics of the decompression ribs 232 and the pinches 342 can be varied as a function of the length of the channels 430, 440. Presence of the pinch 342 in the channel 430 will increase the pressure differential in adjacent channels 440 and drive flow of fuel 32 or oxidant 34 though the gas diffusion layers (GDL) 24, 26 over to the adjacent channel 440.

For example, as shown in a fuel cell 500 of FIG. 5, if an inlet pressure at the entrance 410 of the channel 430 is at about 250 kPa, the pressure may drop to about 247 kPa by the time that the oxidant 34 or fuel 32 reaches a fourth of the distance 412 in the channel 430. Because of the pinch 342 that is present in the channel 430, the pressure may drop to about 244 kPa. However, the neighboring channel 440 is configured such that oxidant 34 or fuel 32 flowing through it has yet to pass its first full pinch 342 at the fourth of the channel distance 412, and has a pressure of about 247 kPa.

Thus, there will be a pressure difference at the same location between the first channel 430 and the second channel 440. This pressure difference will induce a secondary flow along the decompression ribs 232 as indicated in FIG. 5 with the arched arrows 460. As flow in the channels 430, 440 progresses, the location of the pinches 342 alternate along the length of the adjacent channels 430, 440. This alternate positioning of the pinches 342 along the channels 430, 440 results in a reversal in the direction of the pressure drop and induces flow of fluids accordingly.

Water accumulation and increased humidity can cause the end 480 of channels 430, 440 to become increasingly susceptible to flooding and or displacement of the cathode oxygen (reactant) molecules. Water accumulation may take place towards the exit of the anode channels 122, where flooding and subsequent displacement of fuel molecules is likely to persist. The location and/or incorporation of decompression ribs 232 and the pinches 342 along the channels 120, 122 may become denser (e.g., closer with less distance between them) at the ends of the channels 120, 122 to accommodate the molecular variation of fuel 32, water, and/or other exhaust components at those locations.

Accordingly, a method of increasing pressure in adjacent channels 430, 440 of the present disclosure may include creating one or more pinches 342 (FIGS. 3A-3C). The method may also include controlling the magnitude of the secondary flow indicated by the arched arrows 460 along the decompression ribs 232 by altering or adjusting pinch 342 characteristics and/or locations. Pinch 342 characteristics may include one or more factors, such as length of the pinched section 420, width of the pinch 342, and/or height of the pinch 342. Pinch 342 locations along the channel 430, 440 may be positioned to be offset, adjacent, overlapping, etc.

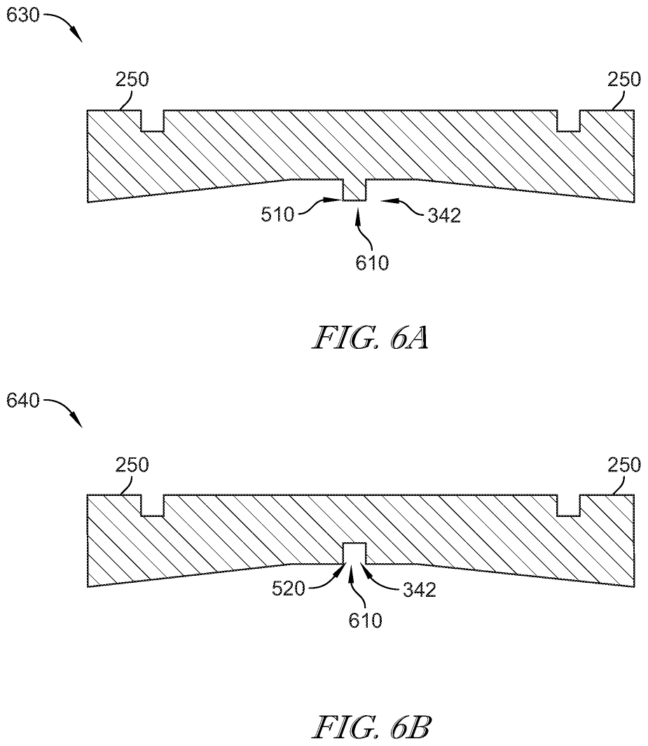

Additionally, as shown in FIGS. 6A and 6B, the pinch 342 or a channel 630, 640 may also have sub-features 510, 520. The sub-features 510, 520 of the pinch 342 or the channel 630, 640 aid in assembly and/or maintaining the required flow and/or pressure drop across the length of the channel 630, 640. Exemplary sub-features 510, 520 of the pinch 342 or the channel 630, 640 include one or more of a dimple 520 (FIG. 6B) or a notch 510 (FIG. 6A). The notch 510 may comprise parallel, tapered, or curved edges (e.g., a shim). These sub-features 510, 520, as well as other features and/or characteristics of one or more pinches 342 or channels 630, 640 may be manipulated to provide the desired primary or secondary flow or pressure (e.g., pressure drop) in the channels 630, 640.

As shown in FIGS. 6A and 6B, in one embodiment, the dimple 520 may be added to the base of the channel 630, 640, in between the side walls 250, on the floor or bottom of the channel 630, 640, and/or directly in the center of a pinched section 610. The sub-features 510, 520 (e.g., including their cross-section) may be of any size or shape, including but not limited to circular, oval, square, or rectangular. If the pinch 342 is required to be raised in height, such as due to metal forming constraints or limits, then the dimple 520 may be added to the pinch 342 or channel 640 to maintain electrical contact within the bipolar plate (BPP) 28, 30 assembly.

In some embodiments, a method for increasing the flow through the gas diffusion layers (GDL) 24, 26 or increasing the efficiency of the gas diffusion layers (GDL) 24, 26 may include decompressing the gas diffusion layers (GDL) 24, 26 locally to promote and/or direct the intended secondary flow through the decompression ridge 232. The gas diffusion layers (GDL) 24, 26 may be decompressed directly after the pinch 342 or may be used in conjunction with the pinch 342. The geometry of the decompressing ridges 232 may be developed based on the performance of the fuel cell 20, 300, 400, 500, or the fuel cell stack 12. The depth of the decompression ribs 232, the number of decompression ribs 232 (e.g., there may be more than one decompression ribs 232 between pinches 342), and the width of the decompression ribs 232 affect the secondary flow through the decompression ribs 232.

Referring to FIGS. 1A-6B, the material and structure of the metal bipolar plate (BPP) 28, 30 may affect the conductivity of the fuel cell 20, 300, 400, 500, or the fuel cell stack 12. In some embodiments, the material of the bipolar plate (BPP) 28, 30 is graphite. In other embodiments, the material of the bipolar plate (BPP) 28, 30 is not graphite.

Similarly, the material of the bipolar plate (BPP) 28, 30 may or may not be a similar or different powder-based product that may be prepared by an impregnation and/or solidifying process. Graphite and other such materials of the bipolar plate (BPP) 28, 30 do not have the capacity to retain the necessary strength to support the fuel cell 20, 300, 400, 500, or the fuel cell stack 12 without maintaining a certain minimum width or thickness. However, metal as a material of the bipolar plate (BPP) 28, 30 has no such limitations. Exemplary materials of the present bipolar plate (BPP) 28, 30 includes a metal and/or a combination of one or more metals.

The metal of the bipolar plate (BPP) 28, 30 may be any type of electrically conductive metal. Electrically conductive metals appropriate or the present metal bipolar plate (BPP) 28, 30 include, but are not limited to Austenitic stainless steel (304L, 316L, 904L, 310S), Ferritic stainless steel (430, 441, 444, Crofer), Nickel based alloys (200/201, 286, 600, 625), Titanium (Grade 1, Grade 2), or Aluminum (1000 series, 3000 series). Exemplary metals comprised by the metal bipolar plate (BPP) 28, 30 may be steel, iron, nickel, aluminum, and titanium.

The metal bipolar plate (BPP) 28, 30 may include one or more, multiple, or a plurality of sheets. Sheets of the metal bipolar plate (BPP) 28, 30 may be sealed, welded, stamped, structured, bonded, and/or configured to provide the flow fields 120, 122 for the fuel cell 20 reactants 32, 34 (e.g., two, three, or more reactants). One or more sheets of the metal bipolar plate (BPP) 28, 30 are configured to be in contact, to overlap, to be attached, or connected to one another in order to provide the flow fields 120, 122 for the fuel cell reactants 32, 34.

One or more sheets of the metal bipolar plate (BPP) 28, 30 may be coated for corrosion resistance. In some embodiments, the corrosion resistant coating may be a graphite based coating. Since graphite has the inability to oxidize, it may be advantageous to coat metal with graphite to prevent corrosion and/or oxidation of the bipolar plate (BPP) 28, 30 in order to enhance performance of the fuel cell 20 and/or fuel cell stack 12.

The following described aspects of the present invention are contemplated and non-limiting:

A first aspect of the present invention relates to a fuel cell system. The fuel cell system comprises a membrane electrode assembly, a bipolar plate, and a local feature. The membrane electrode assembly is on a first side of a gas diffusion layer. The bipolar plate is on a second side of a gas diffusion layer, and the bipolar plate comprises at least one channel. Each channel comprises at least one groove and at least one land. The local feature induces a secondary flow from a first groove in a first channel to a second groove in a second channel over a first land separating the first channel and the second channel. The at least one land is adjacent to a compressed section of the gas diffusion layer. The secondary flow increases locally available oxygen and hydrogen at the membrane electrode assembly adjacent to the compressed section of the gas diffusion layer.

A second aspect of the present invention relates to a method of operating a fuel cell stack. The method comprises operating a plurality of fuel cells comprising a membrane electrode assembly on a first side of a gas diffusion layer and a bipolar plate on a second side of the gas diffusion layer comprising at least a first channel and a second channel, wherein the first channel and the second channel comprise one or more grooves and one or more lands, increasing a pressure differential between the first channel and the second channel by including a local feature, inducing a secondary flow from a first groove in the first channel to a second groove in the second channel, increasing efficiency of the gas diffusion layer, and decreasing water accumulation in the first groove and the second groove.

In the first aspect of the present invention, the system may comprise a first local feature in the first channel and a second local feature in the second channel. In the first aspect of the present invention, the first local feature may be a first pinch and the second local feature may be a second pinch. In the first aspect of the present invention, the first local feature may have the same configuration as the second local feature.

In the first aspect of the present invention, the local feature may include at least one local decompression rib. In the first aspect of the present invention, the local feature may include at least one pinch. In the first aspect of the present invention, the local features may include a dimple or a notch.

In the first aspect of the present invention, a frequency of the local feature may depend on a length of the channel, and the local feature may be positioned along the length of the channel. In the first aspect of the present invention, the frequency of the local feature along the channel may increase as the channel length progresses.

In the first aspect of the present invention, the local feature may be positioned along the length of the channel.

In the second aspect of the present invention, inducing the secondary flow may include at least one pinch. In the second aspect of the present invention, inducing the secondary flow may include a dimple or a notch. In the second aspect of the present invention, the method may further comprise controlling the magnitude of the secondary flow by altering the characteristics of the at least one pinch, and altering the characteristics may include changing at least one of a length of a pinched section, a width of the pinch, or a height of the pinch.

In the second aspect of the present invention, inducing a secondary flow may include at least one local decompression rib. In the second aspect of the present invention, increasing efficiency of the gas diffusion layer may include decompressing the gas diffusion layer locally to direct the secondary flow through a decompression ridge. In the second aspect of the present invention, inducing a secondary flow may include introducing a local pressure drip.

In the second aspect of the present invention, a frequency of the local feature may depend on a length of the channel, and the local feature may be positioned along the length of the channel. In the second aspect of the present invention, the frequency of the local feature along the channel may increase as the channel length progresses.

In the second aspect of the present invention, the local feature may be positioned along the length of the channel.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell system comprising:
a membrane electrode assembly on a first side of a gas diffusion layer,
a bipolar plate on a second side of the gas diffusion layer comprising at least one channel, each channel comprising at least one groove and at least one land, and
a local feature inducing a secondary flow from a first groove in a first channel to a second groove in a second channel over a first land separating the first channel and the second channel,
wherein the at least one land is adjacent to a compressed section of the gas diffusion layer, and
wherein the secondary flow increases locally available oxygen and hydrogen at the membrane electrode assembly adjacent to the compressed section of the gas diffusion layer.

2. The system of claim 1, comprising a first local feature in the first channel and a second local feature in the second channel.

3. The system of claim 2, wherein the first local feature is a first pinch and the second local feature is a second pinch.

4. The system of claim 3, wherein the first local feature has the same configuration as the second local feature.

5. The system of claim 1, wherein the local feature includes at least one local decompression rib.

6. The system of claim 1, wherein the local feature includes at least one pinch.

7. The system of claim 6, wherein the local features include a dimple or a notch.

8. The system of claim 1, wherein the local feature is positioned along the length of the channel.

9. The system of claim 1, wherein a frequency of the local feature depends on a length of the channel.

10. The system of claim 9, wherein the frequency of the local feature along the channel increases as the channel length progresses.

11. A method of operating a fuel cell stack comprising:
operating a plurality of fuel cells comprising a membrane electrode assembly on a first side of a gas diffusion layer and a bipolar plate on a second side of the gas diffusion layer comprising at least a first channel and a second channel, wherein the first channel and the second channel comprise one or more grooves and one or more lands,
increasing a pressure differential between the first channel and the second channel by including a local feature,
inducing a secondary flow from a first groove in the first channel to a second groove in the second channel,
increasing efficiency of the gas diffusion layer, and
decreasing water accumulation in the first groove and the second groove.

12. The method of claim 11, wherein inducing the secondary flow includes at least one pinch.

13. The method of claim 12, wherein inducing the secondary flow includes a dimple or a notch.

14. The method of claim 12, further comprising controlling the magnitude of the secondary flow by altering the characteristics of the at least one pinch, and wherein altering the characteristics includes changing at least one of a length of a pinched section, a width of the pinch, or a height of the pinch.

15. The method of claim 11, wherein inducing a secondary flow includes at least one local decompression rib.

16. The method of claim 11, wherein increasing efficiency of the gas diffusion layer includes decompressing the gas diffusion layer locally to direct the secondary flow through a decompression ridge.

17. The method of claim 11, wherein inducing a secondary flow includes introducing a local pressure drop.

18. The method of claim 11, wherein a frequency of the local feature depends on a length of the channel.

19. The method of claim 18, wherein the frequency of the local feature along the channel increases as the channel length progresses.

20. The method of claim 11, wherein the local feature is positioned along the length of the channel.
